(19) United States
(12) Patent Application Publication
(10) Pub. No.: US 2014/0193561 A1
(43) Pub. Date: Jul. 10, 2014

(54) ADDITIVE FOR CARBONATED BEVERAGE

(71) Applicants: Shuichi MURANISHI, Okayama (JP); Kazuyuki MIYAKE, Saitama (JP); Takashi UESUGI, Chiba (JP); Yuka Mori, Chiba (JP); Toshio MIYAZAWA, Chiba (JP)

(72) Inventors: Shuichi MURANISHI, Okayama (JP); Kazuyuki MIYAKE, Saitama (JP); Takashi UESUGI, Chiba (JP); Yuka Mori, Chiba (JP); Toshio MIYAZAWA, Chiba (JP)

(73) Assignee: OGAWA & CO., LTD., Tokyo (JP)

(21) Appl. No.: 14/202,610

(22) Filed: Mar. 10, 2014

Related U.S. Application Data
(63) Continuation of application No. 11/722,132, filed on Jun. 19, 2007, now abandoned.

(30) Foreign Application Priority Data
Dec. 20, 2004 (JP) 2004-367385

(51) Int. Cl. A23L 2/52

(52) U.S. Cl. CPC A23L 2/52
USPC 426/534

(57) ABSTRACT

The present invention relates to a thirst-quenching carbonated beverage with a strengthened or sustained carbonation feel peculiar to known carbonated beverages in which, after opening, the carbonation feel rapidly drops depending upon a combination of raw materials employed and upon evaporation of the carbon dioxide gas.

The present invention also relates to a method which includes adding to a carbonated beverage an additive comprising spilanthol or a spilanthol-containing plant extract or plant essential oil as an active ingredient.

### CROSS-REFERENCE TO RELATED APPLICATIONS

This application is a Continuation of Application No. 11/722,132 filed on Jun. 19, 2007. Application Ser. No. 11/722,132 is a National Stage of PCT/JP2005/23221 filed on Dec. 19, 2005. This application is based upon and claims the benefit of priority to Japanese Application No. 2004-367385 filed on Dec. 20, 2004.

### TECHNICAL FIELD

The present invention relates to an additive for carbonated beverages that comprises as the active ingredient spilanthol or a spilanthol-containing plant extract or plant essential oil, to carbonated beverages and flavorings for carbonated beverages that contain the aforementioned additive, and to a method of enhancing or maintaining the carbonated feel of carbonated beverages by addition of the additive.

### BACKGROUND ART

Carbonated beverages such as soda pops and colas add pleasure to daily life and have long been popular types of soft drinks among children and adults. They are particularly enjoyed as thirst quenching beverages in hot summer periods or when perspiring after exercise. Carbonated beverages have a characteristic “carbonated feel” (an intense, refreshing stimulation on the throat produced by carbon dioxide gas, or a cool (refreshing) feel created by the combination of carbon dioxide gas and flavor) not shared by other types of soft drinks, which contributes to its effect of quenching thirst. However, carbonated beverages may not exhibit a satisfactory carbonated feel when prepared in combination with added substances such as juices, sweeteners, color additives, flavorings and the like. Furthermore, when rapid escape of carbon dioxide gas occurs after cap opening, resulting in “flatness”, the carbonated beverage loses the essential intense, refreshing stimulation of the carbon dioxide gas, thereby reducing the carbonated feel and quickly lowering the palatability after the cap has been opened.

Carbonated beverages hitherto proposed include carbonated beverages containing specific proportions of high-sweetness sweeteners in formulations containing relatively large amounts of carbon dioxide gas and plant components such as fruit juices, to provide a soothing, refreshing feel along with both the rich taste of the plant components and the stimulation of carbon dioxide gas (Patent document 1), and carbonated beverages with enhanced quality of taste including stimulation, creamy texture and rich taste, produced with addition of DE9-20 amylolysis product to the carbonated beverages (Patent document 2). However, no methods are yet known for enhancing the carbonated feel, including the stimulating and refreshing feel of carbon dioxide gas, which is reduced due to the effects of other materials in the beverage and escape of gas after cap opening.
[Patent document 1] WO 2002/067702
[Patent document 2] JP 2002-330735 A

### DISCLOSURE OF INVENTION

### Problems to be Solved by the Invention

It is an object of the present invention to solve the problems of reduced carbonated feel resulting from combination with added materials such as fruit juices, sweeteners, color additives and flavorings, of reduced carbonated feel caused by rapid escape of carbon dioxide gas after cap opening, and of accelerated loss of function or palatability as a thirst-quenching beverage after opening of the cap.

### Means for Solving the Problems

As a result of research on materials that enhance the carbonated feel of carbonated beverages with the aim of solving the problems described above, the present inventors have completed this invention upon discovering that addition of a small amount of spilanthol enhances the desirable stimulation of carbonation produced by carbon dioxide gas, thereby enhancing and maintaining the carbonated feel of beverages.

Specifically, the present invention provides an additive for carbonated beverages that comprises as the active ingredient spilanthol or a spilanthol-containing plant extract or plant essential oil, as well as an additive for carbonated beverages wherein the spilanthol-containing plant is Spilanthes acmella or Spilanthes acmella var. oleracea.

The invention further provides a flavoring composition for carbonated beverages characterized by containing the aforementioned additive for carbonated beverages. The invention still further provides carbonated beverages characterized by containing the aforementioned additive for carbonated beverages or flavoring composition for carbonated beverages, wherein the carbonated beverages contain spilanthol at 1-300 ppb. The carbonated beverages are also characterized by having citrus-based flavors.

The invention still further provides a method for enhancing or maintaining the carbonated feel of a carbonated beverage, by addition of the aforementioned additive for carbonated beverages or flavoring composition for carbonated beverages to a spilanthol content of 1-300 ppb in the carbonated beverage.

### Effect of the Invention

Addition of the additive for carbonated beverages of the invention to a carbonated beverage prevents loss of the carbonated feel that occurs by combination with materials such as fruit juices, sweeteners and the like. Moreover, loss of the carbonated feel due to escape of carbon dioxide gas after cap opening is minimized, and the intended function and palatability as a thirst-quenching beverage is maintained even after opening of the cap.

### BEST MODE FOR CARRYING OUT THE INVENTION

The spilanthol used for the invention is N-isobutyl-2,6,8-decatrieneamide, represented by the chemical formula shown below, which is a pungent component found in Spilanthes acmella, Spilanthes acmella var. oleracea, and other varieties.

CH₃CH═CH—CH═CH(CH₂)₂CH═CHCONHCH₂CH(CH₃)₂

Spilanthol can be obtained by extraction and purification from these plants, or it may be chemically synthesized. Spilanthol obtained by any such methods may be used for the invention, and it does not need to be a highly purified form. Spilanthol-containing plant extracts or essential oils may be used without purification so long as their tastes and odors do not adversely affect the flavor of the carbonated beverage. From the viewpoint of safety it is preferred to use extracts or essential oils obtained from proven edible plants, while from the viewpoint of supply, cost and other practical factors, it is particularly preferred to use extracts or essential oils of Spilanthes acmella or Spilanthes acmella var. oleracea, which have high spilanthol contents.

The spilanthol may be obtained by extraction or distillation from the total herb or flower head of Spilanthes acmella or Spilanthes acmella var. oleracea, which have high spilanthol contents. Using extraction for the sake of illustration, flower heads of Spilanthes acmella or Spilanthes acmella var. oleracea are dried and crushed and then subjected to extraction with an organic solvent to obtain a spilanthol-containing extract. The organic solvent used for extraction is not particularly restricted, and may be an alcohol such as methanol, ethanol, propanol or propylene glycol, a ketone such as acetone, an ester such as ethyl acetate, an ether such as diethyl ether or a hydrocarbon such as hexane or heptane, either alone or in admixture as appropriate. A polar organic solvent such as an alcohol is preferred, with ethanol being particularly preferred from the standpoint of safety. The solvent is distilled off from the obtained extract solution to obtain the spilanthol-containing extract.

The spilanthol-containing extract may be used directly as an additive for carbonated beverages according to the invention, but in cases where components other than the spilanthol in the extract may adversely affect the taste of the carbonated beverage, it is preferred to increase the spilanthol content by a purification method such as distillation.

The purification method may be molecular distillation, thin-film distillation or a chromatography method, and such purification methods may be used alone or in appropriate combinations to obtain an additive for carbonated beverages with a higher spilanthol content.

The additive for carbonated beverages of the invention may be added alone to a carbonated beverage, but it may also be combined with any other desired flavoring components for use in a flavoring composition for carbonated beverages. Flavoring components to be used in combination therewith are not particularly restricted, and as suitable examples there may be mentioned synthetic and natural-derived flavorings such as ethyl acetoacetate, acetophenone, anisaldehyde, α-amylcinnamaldehyde, methyl anthranilate, ionone, isoeugenol, isoamyl isovalerate, ethyl isovalerate, allyl isothiocyanate, 3-butenyl isothiocyanate, 4-pentenyl isothiocyanate, benzyl isothiocyanate, 3-methylthiopropyl isothiocyanate, other isothiocyanates, indole and its derivatives, γ-undecalactone, esters, ethylvanillin, ethers, eugenol, octanol, octanal, ethyl octanoate, isoamyl formate, geranyl formate, citronellyl formate, cinnamic acid, ethyl cinnamate, methyl cinnamate, ketones, geraniol, isoamyl acetate, ethyl acetate, geranyl acetate, cyclohexyl acetate, citronellyl acetate, cinnamyl acetate, terpinyl acetate, phenethyl acetate, butyl acetate, benzyl acetate, 1-menthyl acetate, linalyl acetate, methyl salicylate, cyclohexylallyl propionate, citral, citronellal, citronellol, 1,8-cineol, fatty acids, aliphatic higher alcohols, aliphatic higher aldehydes, aliphatic higher hydrocarbons, cinnamyl alcohol, cinnamaldehyde, thioethers, thiols, decanal, decanol, ethyl decanoate, terpineol, limonene, pinene, myrcene, terpinolene, terpene-based hydrocarbons, γ-nonalactone, vanillin, paramethylacetophenone, hydroxycitronellal, hydroxycitronellaldimethylacetal, piperonal, isoamyl phenylacetate, isobutyl phenylacetate, ethyl phenylacetate, phenol ethers, phenols, furfural and its derivatives, propionic acid, isoamyl propionate, ethyl propionate, benzyl propionate, hexanoic acid, allyl hexanoate, ethyl hexanoate, ethyl heptanoate, 1-perillaldehyde, benzyl alcohol, benzaldehyde, aromatic alcohols, aromatic aldehydes, d-borneol, maltol, methyl N-methylanthranilate, methyl β-naphthylketone, dl-menthol, l-menthol, butyric acid, isoamyl butyrate, ethyl butyrate, cyclohexyl butyrate, butyl butyrate, lactones, linalool and the like; Essential oils of citrus fruits such as orange, lemon, lime and grapefruit, essential oils or recovered flavors of fruits such as apple, banana, grape, melon, peach, pineapple and strawberry, extract flavors of dairy products such as such as milk, cream, butter, cheese and yogurt, recovered flavors of palatable products such as green tea, black tea, coffee and cocoa, or essential oils of mints such as peppermint and spearmint, as well as spice extracts obtained from hemp seed, asafoetida, ajowan, anise, angelica, fennel, turmeric, oregano, allspice, orange peel, szechuan pepper, cassia, chamomile, brassica juncea, cardamom, curry tree or curry-leaf tree, liquorice, caraway, zhi pear, cumin, water cress, clove, poppy seed, caper, pepper, sesame, coriander, sassafras, saffron, savory, salvia, sichuan pepper, beefsteak plant, cinnamon, shallot, juniper berry, ginger, star anise, spearmint, horseradish, celery, sorrel, thyme, onion, tamarind, tarragon, chive, dill, pepper, nutmeg, wormwood, nigella, ginseng, garlic, basil, parsley, peppermint, vanilla, Chinese chive, bell pepper, hyssop, Fenugreek, peppermint, horsemint, horseradish, marjoram, myoga, lavender, linden, lemongrass, lemon balm, rose, rosemary, bay, horseradish and the like, or natural spices obtained from Iceland moss, rehman di huang, akebia, cannabis, asafoetida, maidenhair fern, ajowan, azuki bean, rooibos, applemint, artichoke, anise, avocado, hydrangea, jiaogulan, fritilla lily, amyris, sweet cicely, almond, epazote, alkanet, artemisia, arnica, alfalfa, aloe, angostura, angola weed, apricot, chanterelle, angelica, amber, ambergris, ambrette, squid, barrenwort, rush, yeast, Japanese knotweed, strawberry, fig, ginkgo, oxknee, ylangylang, hedysa huang qi, imperatoria, immortelle, wintergreen, watercress, ivy, turmeric, usubasai wild ginger, woodruff, sea urchin, ume, oolong tea, peril sesame, enokitake, shrimp, ebisugusa, erigeron, elder, eleutherococcus, elecampane, elemi, engosaku, huai jiao, endive, blessed thistle, huang lian, plantain, cnidium fruit, krill, oak, oakmoss, mole cricket, osmanthus, opoponax, ominaeshi, water plantain, origanum, orris, olibanum, olive, allspice, orange, orangeflower, seaweed, kaininso, cacao, persimmon, fruit vegetables, cashew nut, cascara, cascarilla, castoreum, kataku chestnut, dried skipjack, cassie, purging cassia, catechu, crab, carnation, valerian, chamomile, cajeput, mustard, karasuuri, crowdipper, guarana, calamus, galanga, currant, carissa, Chinese quince, cardamom, galbanum, curry, kawamidori, liquorice, gambir, Chinese olive, kiwifruit, kikaiga seaweed, take, baloonflower, ju hua, Jew's ear, kisas bamboo grasse, gishigishi, kidachi, aloe, Peruvian bark, kihada, kibanao huang qi, giboshi, gymnema sylvestre, catnip, caraway, carob, cucumber, quillaia, agrimony, guava, guaiacum, you qi zi, kusasugik cedarura, Japanese quince, kudzu, camphor, kamala, gooseberry, zhi pear, cubeb, bearberry, peach, oleaster, cumin, ground ivy, kurara, clary sage, cranberry, chestnut, walnut, cream, grains of paradise, dittany of crete, water-pepper, dittany, grapefruit, clover, clove, kuromoji, mulberry, quassia, caper, getto, cade, quebracho, germander, kencur, Japanese rais pear, gennoshoko, koji, koutake, black tea, kohone, coca, skullcap, brown sugar, cereals, coco nut, wu zhu yu, pepper, costus, costmary, copaiba, coffee, kobushi, burdock, sesame, cola, coriander, coltsfoot, golden rod, calumba, root vegetable, condurango, comfrey, cypress, fish, cherry flower, cherry, pomegranate, sake cake, bamboo grass, sasakusa, sea buckthorn, sassafras, saffron, sapodilla, cactus, sarashina pearoma, sarsaparilla, salsify, polypore, hawthorn, shan zhu yu, sichuan pepper, Santa herb, sandarac, sandalwood, red sandalwood, shiitake, genet, beefsteak plant, cedar, citrus, citronella, schinus, civet, simaro ruea, shimeji, Chinese peony, jasmin, Mondo grass, jaborandi, shallot, shukusha, juniper berry, ginger, soy, soy sauce cake, spirits, shoro, elm mushroom, tamogitake, ginseng, cinnamon, vinegar, watermelon, squid, narcissus, cedar, star anise, starfruit, styrax, terrapin, suppontake, zdravetz, snakeroot, spikenard, spruce, spearmint, purslane, sloe berry, savory, grassy-leaved sweet flag, sage, zedoary, senega, geranium, celery, senkyu, centaury, sendan, St. John's wort, senna, sauce, rhubarb, soybean, thyme, bamboo shoot, octopus, water-pepper, davana, egg, royal agaric, onion, tamarind, damiana, tamogitake, tarragon, angelica tree, tansy, tangerine, dandelion, cherimoya, cherry la bay, wild cherry, Cogon Grass, chicory, cheese, chichitake, chive, chervil, champaca, tuber rose, wu wei zi, chirata, fern-ally, pickled products, ivy, camellia, tsuyukusa, tsuriganeni ginseng, tsurudoku chameleon, deertongue, thistle, dittany, dill, date, lindera root, tenma, pepper, toki, proteins, oils and fats, molasses, cornsilk, chameleon, eucommia, dog grass, tomato, dragon's blood, dorian, truffle, tolu ruelsum, tonka, naginata koju, pear, nasturtium, nut, fermented soybean, Chinese dates, nutmeg, pink, nameko, naratake, ti-tree, cultured lactic acid bacteria solution, ginseng, garlic, nezumimochi, nettle, silk tree, knotgrass, violet, pineapple, hibiscus, malt, chickweed, basil, lotus, hasukappu, parsley, butter, butter oil, buttermilk, birch, honey, patchouli, peppermint, bagbean, fermented alcoholic beverages, fermented sea urchinik, fermented seasoning, passion fruit, hatsutake ivy, buffaloberry, Job's tears, hanasuge, banana, vanilla, Chinese chive, honeysuckle, papaya, burberry, hamago, hamasuge, rugosa rose, hama fang feng, winter bloom, rose, palma mallowa, sugar apple, ling zhi, hikiokoshi, water chestnut, pistachio, hyssop, hickory, peanut, cypress, hiba, popsissewa, himehagi, hyacinth, hiratake, loquat, areca nut, feijoa, Fenugreek, fennel, fujibakama, fujimodoki, bran, fusel oil, petitgrain, buchu, grape, wine sake cake, rose apple, peach, beech, bunaharitake, black caraway, blackberry, plum, bryonia, prickly ash, primrose, prunella, blueberry, breadfruit, hay, bay, hazel nut, vetiver, betel, safflower, pennyroyal, peppermint, snake, pepino, peptone, bergamot, bergamot mint, Peru balsam, verbena, veronica, benzoin, rosewood, rose, horehound, haw, houkitake, houshou, fang feng, whey, honoki, horsemint, horseradish, peony, hop, poppy, poplar, papaw, jojoba, sea squirt, bordeaux, boronia, maitake, mugwort, marshmallow, marjoram, mastic, massoi, catnip, matico, pine, matsuoji, mushroom, matsutake, matsubusa, poria, mate tea, bean, marigold, garden rhubarb, quince, mullein, mallow, mango, mangosteen, tangerine, chai chai hu, miso, mitsumata, bees wax, meat, mimoza, myoga, milk, myrtle, milfoil, myrrh, myrobalan, roasted barley, musk, gromwell, mesquite, meadowsweet, motherwort, maple, melissa, melilot, melon, sundew, cultured Moniliaceae solution, fir, peach, Jew's mallow, yakuchi, bayberry, peach, eucalyptus, yukinoshita, yuzu, yucca, lily, leaf vegetables, yoroigusa, lionsfoot, litchi, life everlasting flower, lime, lilac, rakanka, long-leaved podocarp, raspberry, rhatany, radish, labdanum, lavender, lungwort, lungmoss, ramboutan, liqueur, leek, litsea, linaloe, longan, ryofunso, green tea, apple, linden, gentian, rue, borage, reseda, lemon, lemongrass, lian qiao, lotus, wax jambu, rosemary, lovage, bay, longose, horseradish, watafujiutsugi, wormwood, wormseed, bracken, burnet and the like.

When an additive for carbonated beverages or a flavoring composition containing an additive for carbonated beverages according to the invention is added to a carbonated beverage, it prevents loss of the carbonated feel that occurs by mixture with materials such as fruit juices, sweeteners and the like, while also preventing a reduced carbonated feel due to escape of carbon dioxide gas after opening of the cap.

There are no particular restrictions on the amount added to a carbonated beverage, but generally the spilanthol content in the final carbonated beverage product is preferred to be 1-300 ppb, more preferably 5-150 ppb and even more preferably 15-100 ppb. A spilanthol content of less than 1 ppb may not produce a sufficient effect, while a spilanthol content of greater than 300 ppb will tend to bring out the pungency of the spilanthol. Spilanthol is used in oral compositions such as dental pastes to enhance the refreshing feel of menthol and the like (JP S48-43870 B), but the amount of spilanthol added is 1 ppm or greater in such oral compositions; in contrast, the additive for carbonated beverages of the invention provides a maintaining and enhancing effect on the carbonated feel even with an addition amount of below 1 ppm.

The term “carbonated beverage” generally refers to beverages having carbon dioxide gas injected into water and beverages further containing sweeteners, acidulants, flavorings and the like, but according to the invention the term “carbonated beverage” also includes carbon dioxide-containing alcohol beverages.

As examples there may be mentioned carbonated water, carbonated beverages (soda pop, lemonade, etc.) with added flavors such as lemon, lemon-lime, lime, orange, grapefruit, grape, apple and the like, ginger ale, cola carbonated beverages, fruit juice-containing carbonated beverages, dairy product-containing carbonated beverages, carbon dioxide-containing liquors such as canned chu-hi, sparkling wine, beer, low-malt beer (Happoshu) and the like, although there is no limitation to these.

Also, as mentioned above, the term “carbonated feel” used for the purpose of the invention refers to an intense, refreshing stimulation on the throat produced by carbon dioxide gas, or a cool (refreshing) feel created by the combination of carbon dioxide gas and flavor, and the additive for carbonated beverages of the invention exhibits a particularly notable effect for soda pop beverages with citrus-based flavors, or cola carbonated beverages. Because the effect is particularly notable for enhancing citrus-based flavors, the additive is preferably used for carbonated beverages with citrus-based flavors.

### EXAMPLES

The present invention will now be explained in greater detail through examples.

### Production Example 1

### Crude Spilanthol 1

To 10 kg of dried flower heads of Spilanthes acmella (crushed to about 5 mm) there was added 100 kg of 99 volt ethanol, and extraction was carried out at 75° C. reflux temperature for 5 hours. After cooling the extract solution to 40° C., the solid and liquid portions were separated with a centrifugal separator and the extract was concentrated to 20 kg under reduced pressure. After adding 0.2 kg of active carbon to the concentrate and stirring for 1 hour, diatomaceous earth was added, pressure filtration was performed to remove the active carbon, and the extract was further concentrated under reduced pressure to obtain 0.43 kg of a Spilanthes acmella concentrate. Next, 2 kg of distilled water was added to the concentrate and extraction was performed three times with 2 kg of ethyl acetate.

The extracted ethyl acetate layers were pooled, diatomaceous earth was added, pressure filtration was performed, and the mixture was concentrated under reduced pressure to obtain 0.31 kg of a Spilanthes acmella crude extract. Yield: 3.1%. Spilanthol content: 12.4%.

After combining 100 g of the Spilanthes acmella crude extract to 100 g of fatty acid triglycerides, a reduced pressure thin-film distillation apparatus was used for distillation at a degree of vacuum of 3-5 Pa and a vaporization surface temperature of 110-150° C., to obtain 33.3 g of distillate. Yield: 33%. Spilanthol content: 38.0 wt %.

A 0.1 g portion of the distillate was diluted with 760 g of a 50 wt % ethanol aqueous solution, and after cooling to 5° C., diatomaceous earth was added and the mixture was filtered to prepare a crude spilanthol solution 1 with a spilanthol concentration of 50 ppm (w/w).

### Production Example 2

### Crude Spilanthol 2

With 100 g of the Spilanthes acmella crude extract of Production Example 1 (spilanthol content: 12.4%) there was mixed 50 g of fatty acid triglycerides, and a reduced pressure thin-film distillation apparatus was used for distillation at a degree of vacuum of 4-5 Pa and a vaporization surface temperature of 120° C., to obtain 12.3 g of distillate. Yield: 12.3%. Spilanthol content: 67.3 wt %.

A 0.1 g portion of the distillate was diluted with 1346 g of a 50 wt % ethanol aqueous solution, and after cooling to 5° C., diatomaceous earth was added and the mixture was filtered to prepare a crude spilanthol solution 2 with a spilanthol concentration of 50 ppm (w/w).

### Production Example 3

### Purified Spilanthol

A 300 g portion of dried flower heads of Spilanthes acmella was subjected to reflux extraction for 1 hour with 3200 g of 95 vol % ethanol. The extract solution was cooled, the solid and liquid portions were separated, and diatomaceous earth was added for filtration. The filtration was concentrated under reduced pressure to remove the ethanol, and then 300 g of water was added and extraction was performed three times with 300 ml of hexane. The extracted hexane layers were combined and concentrated under reduced pressure for removal of the hexane to obtain 8.4 g of a crude extract. Yield: 2.8% (spilanthol content: 9.5%).

An 8.4 g portion of the crude extract was fractionated (elution with n-hexane:ethyl acetate=8:2) by silica gel column chromatography (200 g of silica gel, φ5 cm), and the spilanthol fraction (Rf value=0.2-0.3, n-hexane:ethyl acetate=7:3) was separated off and the solvent was distilled off under reduced pressure to obtain 2.76 g of a crude spilanthol fraction 1. The crude spilanthol fraction 1 was then subjected to simple distillation and purification (180° C.) using a Kugel-Rohr distilling apparatus under reduced pressure (0.1 mmHg) to obtain 0.98 g of a crude spilanthol fraction 2. Yield: 0.33% (spilanthol content: 41.9%).

An 0.98 g portion of the crude spilanthol fraction was further fractionated (elution with n-hexane:ethyl acetate=95:5-90:10) by silica gel column chromatography (200 g of silica gel, (115 cm), and then the spilanthol fraction (Rf value=0.2, n-hexane:ethyl acetate=7:3) was separated off and the solvent was distilled off under reduced pressure to obtain 0.52 g of purified spilanthol. Yield: 0.17%. Spilanthol content: 98 wt %. The spilanthol structure was confirmed by proton and 13C NMR measurement in comparison with the known published data.

A 0.104 g portion of the purified spilanthol was diluted with 2000 g of a 50 wt % ethanol solution to prepare a purified spilanthol solution with a spilanthol concentration of 50 ppm (w/w).

### Example 1

### Diet Soda Pop Beverage

To 295.22 g of distilled water there were added 0.08 g of sucralose, 0.3 g of Acesulfame K, 1 g of citric acid, 0.8 g of malic acid, 0.5 g of vitamin C, 1.5 g of soda-pop flavoring (product of Ogawa & Co., Ltd.) and 0.6 g of the crude spilanthol solution of Production Example 1, and the components were uniformly dissolved. The solution was cooled to 5° C. in ice water and weighed out to 75 g in a 250 ml volume can.

A diet soda pop carbonated beverage according to the invention was prepared by further adding 175 g of carbonated water to the solution. A diet soda pop carbonated beverage was also prepared in the same manner by addition of the crude spilanthol solution 2 of Production Example 2.

### Comparative Example 1

To 295.22 g of distilled water there were added 0.08 g of sucralose, 0.3 g of Acesulfame K, 1 g of citric acid, 0.8 g of malic acid, 0.5 g of vitamin C, 1.5 g of soda-pop flavoring (product of Ogawa & Co., Ltd.) and 0.6 g of a 50 wt % ethanol aqueous solution, and the components were uniformly dissolved.

The solution was cooled to 5° C. in ice water and weighed out to 75 g in a 250 ml volume can. A diet soda pop beverage for Comparative Example 1 was prepared by further adding 175 g of carbonated water to the solution.

### Test Example 1

The tastes of the diet soda pop beverage of Example 1 and the diet soda pop beverage of Comparative Example 1 were compared by an organoleptic evaluation with a panel of 20 experienced evaluators. The evaluation of carbonated stimulation and flavor strength was conducted on a 7-level scale centered around 4 points as equivalent to the comparative example. The point averages and comments on flavor are shown in Table 1.

### (Score System)

Very strong flavor (highly desirable): 7 points
Strong flavor (desirable): 6 points
Somewhat strong flavor (somewhat desirable): 5 points
Equivalent: 4 points
Somewhat weak flavor (somewhat undesirable): 3 points
Weak flavor (undesirable): 2 points
Very weak flavor (highly undesirable): 1 point

TABLE 1

| | Carbonated | Strength of | |
|---|---|---|---|
| | stimulation | flavor | Comment |
| Comparative | 4.0 | 4.0 | |
| Example 1 | | | |
| Example 1 | 6.6 | 5.5 | Fresh, pleasant |
| Crude | | | feel on throat |
| spilanthol 1 | | | |
| Example 1 | 6.2 | 5.8 | Cool and |
| Crude | | | refreshing |
| spilanthol 2 | | | |

As shown in Table 1, addition of the crude spilanthol to the diet soda pop beverage produced particularly strong carbonation-attributed stimulation with enhanced flavor compared to the comparative example.

### Example 2

### Ginger Ale Beverage

To 15.61 g of distilled water there were added 131.4 g of high-fructose corn syrup, 0.7 g of citric acid, 0.8 g of phosphoric acid, 0.14 g of caramel, 0.05 g of caffeine, 1.0 g of ginger ale flavoring (product of Ogawa & Co., Ltd.) and 0.3 g of the crude spilanthol solution 2 of Production Example 2, and the components were uniformly dissolved. The solution was cooled to 5° C. in ice water and weighed out to 37.5 g in a 250 ml volume can. A ginger ale beverage according to the invention was prepared by further adding 212.5 g of carbonated water to the solution.

### Comparative Example 2

### Ginger Ale Beverage

To 15.61 g of distilled water there were added 131.4 g of high-fructose corn syrup, 0.7 g of citric acid, 0.8 g of phosphoric acid, 0.14 g of caramel, 0.05 g of caffeine, 1.0 g of ginger ale flavoring (product of Ogawa & Co., Ltd.) and 0.3 g of a 50 wt % ethanol aqueous solution, and the components were uniformly dissolved. The solution was cooled to 5° C. in ice water and weighed out to 37.5 g in a 250 ml volume can. A ginger ale beverage for Comparative Example 2 was prepared by further adding 212.5 g of carbonated water to the solution.

### Test Example 2

The tastes of the ginger ale beverage of Example 2 and the ginger ale beverage of Comparative Example 2 were compared by an organoleptic evaluation with a panel of 20 experienced evaluators. The evaluation of carbonated stimulation and flavor strength was conducted on a 7-level scale centered around 4 points as equivalent to the comparative example. The point averages and comments on flavor are shown in Table 2. The score system was the same as for Test Example 1.

TABLE 2

| | Carbonated | Strength of | |
|---|---|---|---|
| | stimulation | flavor | Comment |
| Comparative | 4.0 | 4.0 | |
| Example 2 | | | |
| Example 2 | 6.4 | 6.0 | Fresh, pleasant |
| | | | feel on throat |

As shown in Table 2, addition of the crude spilanthol to the ginger ale beverage produced particularly strong carbonation-attributed stimulation with enhanced flavor compared to the comparative example.

### Example 3

### Diet Cola Beverage

To 142.65 g of distilled water there were added 0.45 g of aspartame, 0.6 g of citric acid, 1 g of phosphoric acid, 0.1 g of caffeine, 2.7 g of caramel, 1 g of cola flavoring (product of Ogawa & Co., Ltd.) and 1.5 g of the crude spilanthol solution 2 of Production Example 2, and the components were uniformly dissolved. The solution was cooled to 5° C. in ice water and weighed out to 37.5 g in a 250 ml volume can.

A diet cola beverage according to the invention was prepared by further adding 212.5 g of carbonated water to the solution. A diet cola beverage was also prepared in the same manner by addition of the purified spilanthol solution 3 of Production Example 3.

### Comparative Example 3

To 142.65 g of distilled water there were added 0.45 g of aspartame, 0.6 g of citric acid, 1 g of phosphoric acid, 0.1 g of caffeine, 2.7 g of caramel, 1 g of cola flavoring (product of Ogawa & Co., Ltd.) and 1.5 g of a 50 wt % ethanol aqueous solution, and the components were uniformly dissolved.

The solution was cooled to 5° C. in ice water and weighed out to 37.5 g in a 250 ml volume can. A diet cola beverage for Comparative Example 3 was prepared by further adding 212.5 g of carbonated water to the solution.

### Test Example 3

The tastes of the diet cola beverage of Example 3 and the diet cola beverage of Comparative Example 3 were compared by an organoleptic evaluation with a panel of 20 experienced evaluators. The evaluation of carbonated feel, flavor strength and palatability was conducted on a 7-level scale centered around 4 points as equivalent to the comparative example. The point averages and comments on flavor are shown in Table 3. The same score system was used as for Test Example 1, but evaluation of palatability was included.

A 250 ml portion of the diet cola beverage was placed in a 300 ml beaker in a refrigerator at 5° C. after opening of the container, and the beverage stored for 30 minutes in the opened state was evaluated in the same manner, giving the results shown in Table 4. The score system was the same as for Test Example 1, with evaluation centered around 4 points as equivalent to the comparative example after 30 minutes in an opened state. Palatability was also included in the evaluation as in Table 3.

TABLE 3

| | | Strength | | |
|---|---|---|---|---|
| | Carbonated | of | | |
| | stimulation | flavor | Palatability | Comment |
| Comparative | 4.0 | 4.0 | 4.0 | |
| Example 3 | | | | |
| Example 3 | 6.6 | 6.0 | 6.2 | Strong |
| Crude | | | | spiciness |
| spilanthol 2 | | | | with |
| | | | | pleasant |
| | | | | aftertaste |
| Example 3 | 6.6 | 6.1 | 6.8 | Strong |
| Purified | | | | spiciness |
| spilanthol | | | | with fresh |
| | | | | taste |

As shown in Table 3, addition of the crude spilanthol or purified spilanthol to the diet cola beverage produced particularly strong carbonation-attributed stimulation with enhanced flavor and improved palatability as a carbonated beverage, compared to the comparative example.

TABLE 4

| | | Strength | | |
|---|---|---|---|---|
| | Carbonated | of | | |
| | stimulation | flavor | Palatability | Comment |
| Comparative | 4.0 | 4.0 | 4.0 | |
| Example 3 | | | | |
| Example 3 | 6.0 | 6.2 | 6.1 | Good |
| Crude | | | | aftertaste |
| spilanthol 2 | | | | with |
| | | | | satisfying |
| | | | | feel |
| Example 3 | 6.1 | 5.8 | 6.4 | Fresh |
| Purified | | | | taste with |
| spilanthol | | | | satisfying |
| | | | | feel |

As shown in Table 4, addition of the crude spilanthol or purified spilanthol to the diet cola beverage produced particularly strong carbonation-attributed stimulation with maintenance of strong flavor and high palatability as a carbonated beverage after 30 minutes in an opened state, compared to the comparative example.

### Example 4

### Cola Beverage

To 15.2 g of distilled water there were added 129.2 g of high-fructose corn syrup, 0.2 g of citric acid, 0.8 g of phosphoric acid, 2.5 g of caramel, 0.1 g of caffeine, 1.0 g of cola flavoring (product of Ogawa & Co., Ltd.) and 1 g of the crude spilanthol solution 2 of Production Example 2, and the components were uniformly dissolved. The solution was cooled to 5° C. in ice water and weighed out to 37.5 g in a 250 ml volume can. A cola beverage according to the invention was prepared by further adding 212.5 g of carbonated water to the solution.

### Comparative Example 4

### Cola Beverage

To 15.2 g of distilled water there were added 129.2 g of high-fructose corn syrup, 0.2 g of citric acid, 0.8 g of phosphoric acid, 2.5 g of caramel, 0.1 g of caffeine, 1.0 g of cola flavoring (product of Ogawa & Co., Ltd.) and 1 g of a 50 wt % ethanol aqueous solution, and the components were uniformly dissolved. The solution was cooled to 5° C. in ice water and weighed out to 37.5 g in a 250 ml volume can. A cola beverage for Comparative Example 4 was prepared by further adding 212.5 g of carbonated water to the solution.

### Test Example 4

The tastes of the cola beverage of Example 4 and the cola beverage of Comparative Example 4 were compared by an organoleptic evaluation with a panel of 20 experienced evaluators. The evaluation was conducted for carbonated feel, strength of flavor, aftertaste and palatability, each on a 7-level scale centered around 4 points as equivalent to the comparative example. The point averages and comments on flavor are shown in Table 5. The score system was the same as for Test Example 1.

TABLE 5

| | Carbonated | Strength of | |
|---|---|---|---|
| | stimulation | flavor | Comment |
| Comparative | 4.0 | 4.0 | |
| Example 4 | | | |
| Example 4 | 6.1 | 6.6 | Strong flavor |
| | | | with fresh feel |

As shown in Table 5, addition of the crude spilanthol to the cola beverage produced particularly strong carbonation-attributed stimulation with enhanced flavor compared to the comparative example.

### Example 5

### 10% Orange Juice-Added Lightly Carbonated Beverage

To 463 g of distilled water there were added 20 g of 5-fold orange concentrate, 114.3 g of high-fructose corn syrup, 1.5 g of citric acid, 0.1 g of vitamin C, 1.0 g of orange flavoring (product of Ogawa & Co., Ltd.) and 0.1 g of the purified spilanthol solution of Production Example 3, and the components were uniformly dissolved.

The solution was cooled to 5° C. in ice water and weighed out to 150 g in a 250 ml volume can.

A 10% orange juice-added lightly carbonated beverage according to the invention was prepared by further adding 100 g of carbonated water to the solution.

### Comparative Example 5

### 10% Orange Juice-Added Lightly Carbonated Beverage

To 463 g of distilled water there were added 20 g of 5-fold orange concentrate, 114.3 g of high-fructose corn syrup, 1.5 g of citric acid, 0.1 g of vitamin C, 1.0 g of orange flavoring (product of Ogawa & Co., Ltd.) and 0.1 g of a 50 wt % ethanol aqueous solution, and the components were uniformly dissolved.

The solution was cooled to 5° C. in ice water and weighed out to 150 g in a 250 ml volume can.

A 10% orange juice-added lightly carbonated beverage for Comparative Example 5 was prepared by further adding 100 g of carbonated water to the solution.

### Test Example 5

The tastes of the 10% orange juice-added lightly carbonated beverage of Example 5 and the 10% orange juice-added lightly carbonated beverage of Comparative Example 5 were compared by an organoleptic evaluation with a panel of 20 experienced evaluators.

The evaluation was conducted for carbonated feel, strength of flavor, aftertaste and palatability, each on a 7-level scale centered around 4 points as equivalent to the comparative example.

The point averages and comments on flavor are shown in Table 6. The score system was the same as for Test Example 1.

TABLE 6

| | Carbonated | Strength of | |
|---|---|---|---|
| | stimulation | flavor | Comment |
| Comparative | 4.0 | 4.0 | |
| Example 5 | | | |
| Example 5 | 5.7 | 4.8 | Fresh feel |

As shown in Table 6, addition of the purified spilanthol to the 10% orange juice-added lightly carbonated beverage produced particularly strong carbonation-attributed stimulation with enhanced flavor compared to the comparative example.

### Example 6

### Lemon chu-hi Beverage

To 168.7 g there were added 180 g of vodka, 6.1 g of transparent lemon 5-fold concentrate, 42 g of high-fructose corn syrup, 0.9 g of citric acid, 2 g of lemon flavoring (product of Ogawa & Co., Ltd.) and 0.3 g of the purified spilanthol solution of Production Example 3, and the components were uniformly dissolved.

The solution was cooled to 5° C. in ice water and weighed out to 100 g in a 250 ml volume can.

A lemon chu-hi beverage according to the invention was prepared by further adding 150 g of carbonated water to the solution.

### Comparative Example 6

### Lemon chu-hi Beverage

To 168.7 g of distilled water there were added 180 g of vodka, 6.1 g of 5-fold concentrated transparent lemon juice, 42 g of high-fructose corn syrup, 0.9 g of citric acid, 2 g of lemon flavoring (product of Ogawa & Co., Ltd.) and 0.3 g of a 50 wt % ethanol aqueous solution, and the components were uniformly dissolved. The solution was cooled to 5° C. in ice water and weighed out to 100 g in a 250 ml volume can. A lemon chu-hi beverage for Comparative Example 6 was prepared by further adding 150 g of carbonated water to the solution.

### Test Example 6

The tastes of the lemon chu-hi beverage of Example and the lemon chu-hi beverage of Comparative Example 6 were compared by an organoleptic evaluation with a panel of 20 experienced evaluators. The evaluation was conducted for carbonated feel, strength of flavor, aftertaste and palatability, each on a 7-level scale centered around 4 points as equivalent to the comparative example. The point averages and comments on flavor are shown in Table 7. The score system was the same as for Test Example 1.

TABLE 7

| | Carbonated | Strength of | |
|---|---|---|---|
| | stimulation | flavor | Comment |
| Comparative | 4.0 | 4.0 | |
| Example 6 | | | |
| Example 6 | 6.6 | 5.8 | Very strong |
| | | | stimulation with |
| | | | refreshing feel |

As shown in Table 7, addition of the purified spilanthol to the lemon chu-hi beverage produced particularly strong carbonation-attributed stimulation with enhanced flavor compared to the comparative example.

### Example 7

### Lemon Juice-Added Lightly Carbonated Beverage

To 361.678 g of distilled water there were added 2.1 g of 5-fold concentrated transparent lemon juice, 95 g of high-fructose corn syrup, 25 g of sucrose, 1 g of citric acid, 0.8 g of sodium citrate, 2.86 g of vitamin C, 0.003 g of vitamin B6, 0.007 g of calcium pantothenate, 0.05 g of safflower pigment, 0.002 g of carotene pigment, 1.0 g of lemon flavoring (product of Ogawa & Co., Ltd.) and 0.5 g of the crude spilanthol solution 2 of Production Example 2, and the components were uniformly dissolved. The solution was cooled to 5° C. in ice water and weighed out to 122.5 g in a 250 ml volume can. A lemon juice-added lightly carbonated beverage according to the invention was prepared by further adding 137.5 g of carbonated water to the solution.

### INDUSTRIAL APPLICABILITY

Addition of an additive for carbonated beverages according to the invention to a carbonated beverage can provide a carbonated beverage with an enhanced and prolonged carbonated feel which is essential for carbonated beverages, as well as a refreshing feel on the throat.

1-9. (canceled)

10. An additive for carbonated beverages, the additive comprising a spilanthol or a spilanthol-containing plant extract or a plant essential oil.

11. The additive for carbonated beverages according to claim 10, wherein the spilanthol-containing plant is Spilanthes acmella or Spilanthes acmella var. oleracea.

12. A flavoring composition for carbonated beverages, comprising the additive according to claim 10.

13. A flavoring composition for carbonated beverages, comprising the additive according to claim 11.

14. A carbonated beverage, comprising the additive according to claim 10.

15. A carbonated beverage, comprising the additive according to claim 11.

16. A carbonated beverage, comprising the flavoring composition according to claim 12.

17. A carbonated beverage, comprising the flavoring composition according to claim 13.

18. The carbonated beverage according to claim 14, comprising 1-300 ppb of spilanthol.

19. The carbonated beverage according to claim 15, comprising 1-300 ppb of spilanthol.

20. The carbonated beverage according to claim 16, comprising 1-300 ppb of spilanthol.

21. The carbonated beverage according to claim 17, comprising 1-300 ppb of spilanthol.

22. The carbonated beverage according to claim 14, having a citrus-based flavor.

23. The carbonated beverage according to claim 15, having a citrus-based flavor.

24. The carbonated beverage according to claim 16, having a citrus-based flavor.

25. The carbonated beverage according to claim 17, having a citrus-based flavor.

26. The carbonated beverage according to claim 18, having a citrus-based flavor.

27. The carbonated beverage according to claim 19, having a citrus-based flavor.

28. The carbonated beverage according to claim 20, having a citrus-based flavor.

29. The carbonated beverage according to claim 21, having a citrus-based flavor.

30. A method for enhancing or maintaining the carbonated feel of a carbonated beverage, the method comprising adding the additive according to claim 10 to a carbonated beverage comprising 1-300 ppb of spilanthol.

31. A method for enhancing or maintaining the carbonated feel of a carbonated beverage, the method comprising adding the additive according to claim 11 to a carbonated beverage comprising 1-300 ppb of spilanthol.

32. A method for enhancing or maintaining the carbonated feel of a carbonated beverage, the method comprising adding the flavoring composition according to claim 12 to a carbonated beverage comprising 1-300 ppb of spilanthol.

33. A method for enhancing or maintaining the carbonated feel of a carbonated beverage, the method comprising adding the flavoring composition according to claim 13 to a carbonated beverage comprising 1-300 ppb of spilanthol.
